(19) United States
(12) Patent Application Publication
(10) Pub. No.: US 2003/0202242 A1
(43) Pub. Date: Oct. 30, 2003

(54) Slide for the microscopic examination of biological fluids

(76) Inventors: Roberto Sgaravatto, Arzergrande (IT); Ulisse Chiarin, Arzergrande (IT)

Correspondence Address: PENNIE & EDMONDS LLP, 1667 K STREET NW, SUITE 1000, WASHINGTON, DC, 20006

(21) Appl. No.: 10/132,722

(22) Filed: Apr. 26, 2002

(51) Int. Cl. G02B 21/00

(52) U.S. Cl. 359/397; 359/368; 359/391; 359/396

(57) ABSTRACT

A slide for the microscopic examination of biological fluids, such as urine, blood, spinal fluids, designed to count particles or elements (e.g., corpuscles) present in a predetermined sample. The slide has two plates made of a transparent material, which distinguish on their inside at least one well that is filled, by capillarity, with drops of biological fluid deposited onto the slide itself. Counting chambers are formed on the bottom of at least one well. Each chamber defines a precise volume of biological fluid to be examined. The slide is characterized by the particular and innovative shape and definition of these counting chambers. In particular, the counting chambers have a bottom surface with a roughness differing from the roughness of the boundary defining or demarcating the counting chamber.

### FIELD OF THE INVENTION

The present invention relates to a slide for the microscopic examination of biological fluids. More particularly, the present invention relates to an improved counting chamber in a slide.

### BACKGROUND OF THE INVENTION

It is well known that, for the microscopic examination of biological fluids such as urine, blood, and spinal fluids, so-called “slides” are used to count the number of a given type or types of particles present in a predetermined sample. These slides include two plates made of transparent plastic, one a base and the other a cover plate, which distinguish on their inner surfaces a number of wells. The wells are filled, by capillarity, with drops of a biological fluid deposited onto the slide itself.

Counting chambers are formed on the bottom of each well. Each counting chamber encloses a precise volume of biological fluid to be examined. These counting chambers are obtained through elevations that develop from the bottom of the well to its top.

In relation to the path of the elevations, quadrilateral or circular counting chambers can be obtained, depending on whether the elevations have a rectilinear direction so as to form grids, or a circular direction so as to form mutually separate circles.

Mentioned by way of example for the first type of counting chamber is U.S. Pat. No. 5,128,802 to Mitchell (having a European counterpart patent No. 326 349). This document describes a plastic slide wherein the counting chambers in one well are defined by elevations obtained with symmetrical lines having a breadth of about 0.005 mm to 0.05 mm and extending to the top from the base of that well, preferably for 0.008 mm, and where the minimum reading area of each chamber has an 0.111 mm² base.

Mentioned by way of example for the second type of counting chamber are the slides produced by the KIMA Company, wherein the elevations, with a width of 0.005 mm and 0.05 mm, distinguish a circular counting chamber whose base is a circle with an inside diameter of 0.376 mm.

As a rule, these elevations, whether of the grid or circular type, define nine counting chambers arranged 3×3.

The production for stamping such types of plastic slides requires, to produce elevations with thousandth-part dimensions, the use of stamps equipped with microscopic and well-defined projecting impressions and patterns, which can be made only with special machine tools for the removal of shavings and for electroerosion.

Moreover, by introducing with a dropper the fluid to be examined through the open side of the chamber, the important counting systems are going to be affected, causing localized disturbances, above all near the grids. Moreover, the particles present in the bottom layers of the fluid to be examined are deviated or excluded from the counting system, since they are unable to overcome the barriers caused by the linear elevations that rise to the top of the chamber by about 10% of the total height of the chamber. In other words, because the grids are formed by elevated lines, particles or elements in the fluid to be analyzed cannot readily enter the counting chamber, thus affecting the distribution of particles or elements inside the counting chamber. As a result, the count of the particles or elements may not be accurate.

### SUMMARY OF THE INVENTION

The present invention embodies slides without the aforesaid disadvantages, wherein the counting chambers, present in one or more wells, are not defined by elevations projecting from the bottom of the well. Instead, the counting chambers are defined by linear, and preferably rectilinear or circular, markings imprinted on the surface of the bottom of the well, whose dimensions are such as not to alter the “technical” surface of said bottom. In other words, the markings do not delineate counting chambers as a result of a difference in height so that the bottom surface of the well is substantially uniformly planar.

The markings defining the counting chambers may be formed by lines that are visible on the surface of the bottom of the well because of the fact that, upon examination with an optical instrument (e.g., a microscope), they appear opaque. This appearance results from the fact that the markings have a degree-of-roughness value different from the degree-of-roughness value of the remainder of the bottom surface of the respective well.

Specifically, these markings have a degree-of-roughness value greater than that of the base of the well. The base of the well, to assure maximum transparency, must have a finish of optical quality obtainable, at a minimum, with a lapping operation.

According to such manner of forming the counting chambers, there is no longer a requirement for the making of special stamps, and, hence, the use of special machines or electroerosion. Instead, simplified stamping matrices having lapped level surfaces (minimum roughness value) may be used. Such stamping matrices may be used to define the bottom of the well and, through a simple procedure and simple equipment, draw on the aforesaid surfaces lines with a width of several microns. The markings thus created do not penetrate the matrix, but simply change only the degree-of-roughness value of the portions of the surfaces affected by those markings.

These and other features and advantages of the present invention will be readily apparent from the following detailed description of the invention, the scope of the invention being set out in the appended claims.

### BRIEF DESCRIPTION OF THE DRAWINGS

Features of the present invention will be better demonstrated through a description of one possible embodiment of the invention, including but not limited to such embodiment, as illustrated in the attached figures, wherein like reference characters represent like elements, as follows:

FIG. 1 is a perspective and overall view of a slide formed in accordance with the principles of the present invention;

FIGS. 2 and 3 depict detailed views, respectively, of a single counting chamber and the matrix of nine chambers arranged 3×3; and

FIG. 4 depicts a detailed view of an alternative matrix of nine counting chambers arranged 3×3.

### DETAILED DESCRIPTION OF THE INVENTION

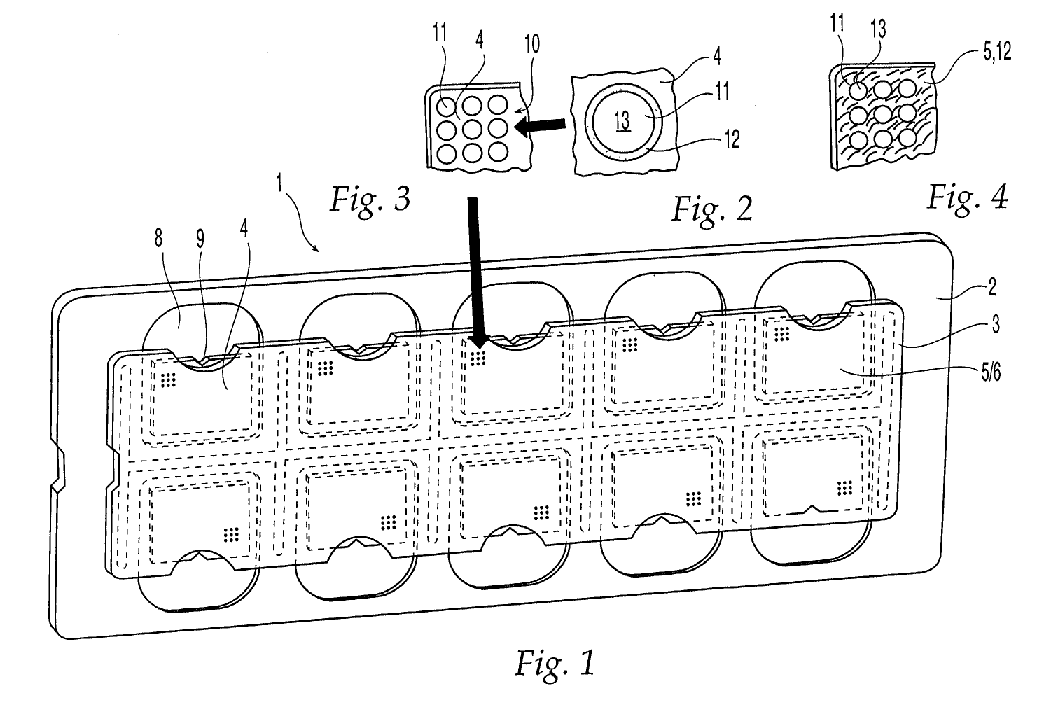

As can be seen in FIG. 1, plastic slide 1 has a bottom plate 2 assembled with a top plate 3. Plates 2 and 3 are preferably bonded together by means of ultrasonic welding, although other techniques of maintaining plates 2, 3 together may be used instead.

Bottom and top plates 2, 3, once assembled, define wells 4, comprising a bottom 5, belonging to bottom plate 2, and a ceiling 6, belonging to top plate 3. Bottom 5 preferably is perfectly level and smooth, with a degree of roughness as low as possible. Ceiling 6 preferably has transparency features such as to permit the best possible microscopic observation, as understood by those of ordinary skill in the art. As such, the finish of the bottom 5 of wells 4, and preferably of ceiling 6 as well, is selected to assure maximum transparency and preferably thus has a finish of optical quality permitting the best and clearest microscopic observation. For instance, at least bottom plate 2 (and preferably also top plate 3) may be created in a mold having a roughness in the range of approximately Ra 0.01 μm to approximately Ra 0.8 μm, such that the resulting plate has a corresponding low degree of roughness and thus high degree of optical quality and clarity.

Each well 4 is filled with a sample drop of biological fluid, which is deposited onto threshold 8 made on bottom plate 2. The fluid penetrates, by capillarity, through an opening 9 into well 4.

In the pattern described, each well may have an area of about 63 mm² and may limit a volume equal to about 6.3 mm³.

On the bottom of each well 4 there is a matrix 10 of nine counting chambers 11, arranged in a series of 3×3. Such grid is standard in the art to obtain a mathematically calculated average of the particles or elements in the fluid to be counted. It will be appreciated that number of counting chambers 11 may be altered as desired without affecting the scope of the invention.

Each counting chamber 11 is defined by a marking 12 delineating a reading area. As illustrated in FIG. 2, marking 12 may be in the form of a line enclosing the reading area. The line may be of any desired thickness, and may have a width of several microns. Preferably, the line is at least thicker than a minimum width necessary to visually differentiate between the bottom surface 13 of counting chamber 11. For example, the width of the line may be approximately 2 to 4 μm, and preferably are smaller than the average dimensions of the elements or particles (e.g., corpuscles) being measured (e.g., approximately 5 μm). In FIGS. 2 and 3, counting chambers 11 are in the form of a circle with an inside diameter of 0.376 mm. However, other shapes, such as rectilinear, are within the scope of the present invention. The surface of marking line 12 has a roughness value greater than the roughness value of the bottom 13 of the aforesaid chamber. The roughness of the bottom 13 of chamber 11 preferably is equal to the roughness value of the bottom 5 of the entire well 4, the former being part of the latter.

It will be appreciated, however, that marking 12 need not have a minimum thickness and may not have a clearly defined thickness at all. In particular, the entire bottom surface 5 of bottom plate 2 may have a roughness different from (and preferably greater than) the roughness of bottom 13 of the counting chamber 11. As such, marking 12 would simply distinguish or delineate an area of a different roughness that constitutes a counting chamber 11. An exemplary grid of counting chamber 11 in an exemplary well 4, defined by a difference in roughness between the bottoms 13 of counting chambers 11 and the bottom 5 of the remainder of well 4, is illustrated in FIG. 4.

By way of example only, we mention the fact that the degree-of-roughness value (i.e., surface roughness) of the bottom 13 of a given counting chamber 11 can be approximately Ra. 0.025 (obtainable with a lapped surface stamp or mold), whereas the corresponding marking 12 defining such counting chamber 11 may have a degree-of-roughness value of approximately Ra. 0.2. Preferably, the roughness of marking 12 is approximately at least five times the roughness of the bottom 13 of counting chamber 11, and may be approximately ten times the roughness. It will be appreciated that calculation of surface roughness is performed by standard methods known to those of skill in the art.

Thus, each marking 12 is configured and dimensioned to render the boundary of each counting chamber 11 distinct from the bottom 13 of a given counting chamber 11. Such distinction is at least discernible as a difference in surface roughness, yet may also be at least marginally visible to the naked eye because of the opacity of marking 12 relative to bottom 13 resulting from the difference in surface roughness. The difference in surface roughness of marking 12 and bottom 13 is preferably no greater than necessary to achieve the above distinctions. Moreover, marking 12 preferably does not alter the technical surface of bottom surface 13. For instance, marking 12 does not alter the planar quality of 15 bottom surface 13. Moreover, because the technical surface of bottom surface 13 is not affected, the flow of the particles or elements (e.g., corpuscles) present in the biological fluid in well 4 (and which sediment in well 4) and which are to be counted is not affected by markings 12. Thus, markings 12 preferably are configured and function simply to delineate visually a reading area in which a measurement or count is to be performed, and do not affect the accuracy of the measurement or count. Preferably, the roughness of marking 12 is still within the range qualifying as meeting the high optical quality demands for plate 2. For instance, the roughness of the entire surface of well 4 (including the bottom 13 of chamber 11, marking 12, and the bottom 5 of well 4) preferably remains in the range of approximately 0.01 μm to approximately 0.8 μm. Thus the particles or elements being measured will not be impeded by markings 12. As a result, an even distribution of the particles or elements is achieved, leading to a more accurate counting then previously possible.

While the foregoing description and drawings represent one embodiment of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. For instance, the form, dimensions, and/or number of both the wells and the counting cells present in each well may be varied. Additionally, or alternatively, the material of the slides may be varied. For instance, non-plastic materials such as glass, but technically equivalent and contingent upon the use made, may be used to form the slides. The presently disclosed embodiments are therefore to be considered in all respects as illustrative and not restrictive, the scope of the invention being indicated by the appended claims, and not limited to the foregoing description.

What is claimed is:

1. A slide for the microscopic examination of biological fluids, said slide comprising:
a transparent base plate having a bottom surface with at least one well defined therein;
a transparent cover plate over said base plate; and
at least one counting chamber having a counting chamber bottom surface visually delineated on said bottom surface of said at least one well by a boundary having a surface roughness different from the surface roughness of said counting chamber bottom surface, said boundary defining a precise counting area in said counting chamber without altering the technical surface of said bottom surface of said at least one well other than by a difference in surface roughness relative to said counting chamber bottom surface.

2. A slide as in claim 1, wherein said boundary comprises a marking on said bottom surface of said at least one well having a roughness greater than the surface roughness of said counting chamber bottom surface.

3. A slide as in claim 2, further comprising a plurality of counting chambers, wherein said marking comprises rectilinear markings defining quadrilaterally shaped counting chambers.

4. A slide as in claim 2, further comprising a plurality of counting chambers, wherein said marking comprises circular markings defining circular counting chambers.

5. A slide as in claim 2, wherein said markings are formed by lines with a minimum width.

6. A slide as in claim 2, wherein said markings appear opaque on said bottom surface of said well as a result of said markings having a surface roughness different from the surface roughness of said counting chamber bottom surface.

7. A slide as in claim 6, wherein said markings have a greater surface roughness than the surface roughness of said counting chamber bottom surface and said counting chamber bottom surface has a finish of optical quality to assure maximum transparency.

8. A slide as in claim 1, wherein said boundary has a surface roughness greater than the surface roughness of said counting chamber bottom surface.

9. A slide as in claim 1, wherein said base plate and said cover plate are fitted together in spaced relation with an opening therebetween such that said at least one well is filled by capillarity through said opening.

10. A slide as in claim 1, wherein said bottom plate and said cover plate are assembled together through ultrasonic welding.

11. A slide as in claim 1, wherein:
said bottom surface of said at least one well is formed by said bottom plate and is perfectly level and smooth with the lowest degree of surface roughness obtainable; and
said cover plate forms a ceiling of said at least one well with transparency properties permitting the very best microscopic observation.

12. A slide as in claim 1, wherein said at least one well comprises a matrix of nine counting chambers arranged in a series of 3×3.

13. A slide as in claim 12, wherein each counting chamber has a respective counting chamber bottom surface and is defined by a marking having a roughness value greater than the surface roughnesses of the counting chamber bottom surfaces.

14. A slide as in claim 13, wherein each said counting chamber bottom surface has a surface roughness equal to the surface roughness of said bottom surface of said well, said counting chamber bottom surfaces being a part of said bottom surface of said well.

15. A slide as in claim 1, wherein said counting chamber bottom surface has a surface roughness equal to the surface roughness of said bottom surface of said well, said counting chamber bottom surfaces being a part of said bottom surface of said well.

16. A slide as in claim 1, wherein said bottom surface of said well, excluding said counting chamber bottom surface, has a surface roughness substantially equal to the surface roughness of said boundary.

17. A slide for the microscopic examination of biological fluids, said slide comprising:
a transparent base plate having a bottom surface with at least one well defined therein;
a transparent cover plate over said base plate; and
at least one counting chamber, defining a precise counting area, formed on said bottom surface of said at least one well and having a counting chamber bottom surface;
wherein:
said bottom surface of said at least one well, excluding said counting chamber bottom surface, has a first surface roughness; and
said counting chamber bottom surface has a second roughness different from said first roughness.

18. A slide as in claim 1, wherein said first roughness is greater than said second roughness.

19. A slide as in claim 1, further comprising a plurality of counting chambers each having a counting chamber bottom surface with a roughness different from said first surface roughness.
